(19) United States
(12) Patent Application Publication
(10) Pub. No.: US 2002/0070870 A1
(43) Pub. Date: Jun. 13, 2002

(54) Boom protection system for dockside container cranes

(75) Inventor: Sun H. Huang, Fremont, CA (US)

Correspondence Address: Bruce & McCoy, Ste. 2360, One Kaiser Plaza, Oakland, CA, 94612, US

(73) Assignee: Paceco Corp.

(21) Appl. No.: 09/737,331

(22) Filed: Dec. 12, 2000

(51) Int. Cl. G08B 21/00

(52) U.S. Cl. 340/685; 340/679

(57) ABSTRACT

A gantry crane boom protection and anti-collision system employing laser guns aimed outboard from the crane superstructure parallel and below the sides thereof with photodetectors to automatically respond to a reflected signal and slow or stop any lateral movement of the crane.

### BACKGROUND OF THE INVENTION

1. Field of the Invention

The present invention relates to a method and apparatus for a boom protection system for dockside cargo container handling cranes. More particularly, it relates to an improvement in boom anti-collision systems. Specifically, it relates to a laser actuated boom protection anti-collision apparatus and system for the boom of a dockside cargo container handling crane for loading and unloading cargo container transport ships.

2. Description of the Prior Art

Dockside cranes for cargo container handling are generally arranged to have a boom which extends in operating configuration over a longitudinal territorial expanse for the purpose of transferring cargo containers horizontally from one pickup and deposition area to another. The largest and heaviest of such cranes are usually located in shipping ports, harbor installations, and in the railroad yards located adjacent to a dockside for the purpose of on loading and off loading cargo containers onto and off of cargo container transport ships. These cranes generally have a cantilever boom which can be extended across the deck of a ship for container on loading and off loading operations. The booms retract to permit the ship to enter or leave the docking berth with either a forward or a rearward motion without mechanical interference with the boom of the crane.

These cargo container handling cranes have either a horizontal sliding boom called a low profile crane or a suspended raisable boom supported by a crane mainframe and superstructure called a gantry crane. The boom of the former type of crane reciprocates in and out in the horizontal plane while the suspended boom of the latter type of crane can usually be raised to retract it by rotating it upward around its inboard end. An example of this latter type of gantry crane is disclosed in U.S. Pat. No. 5,765,981 and was developed by the assignee of the present invention as well as was the horizontal sliding type low profile crane. The boom protection system of the present invention can be utilized with either of these two basic types of crane designs.

The mainframe of a dockside gantry crane generally consists of four legs supported by motor driven wheeled gantry trucks mounted on rails: two legs on the land side rail and two legs on the water side rail. The motor driven gantry trucks or trolleys are mounted at each corner of the crane under the leg structures. The normal distance between the rails, called the rail gauge, varies between 50 to 100 feet. The motor drives on the wheeled trucks allow the crane operator to move the crane along the dock from ship to ship and to the proper position in relation to the container storage positions onboard a ship berthed alongside the dock.

Once a ship is berthed at the dock, the motorized wheeled gantry trucks move the crane with the boom retracted or raised from one ship to another and from one position to the next along the ship after loading or unloading each row of container cells spaced across the beam of the ship.

The main characteristic of a dockside container crane is its long outreach cantilever boom which extends beyond the crane rails and spans over the adjacent water for lifting containers on to and off of a cargo container transport ship. The boom is supported by the superstructure of the crane which is mounted on top of the crane mainframe.

The superstructure for the horizontal sliding crane is low-profile to mini projection into low lying air space above the crane. The superstructure of the suspended boom crane is often referred to as an A frame and projects vertically high above the boom to obtain sufficient mechanical advantage for lifting the boom. The superstructure for either crane includes inboard and outboard girder support beams which are constructed parallel to the edge the dock and to the motorized truck rails or tracks. The outboard support beam is located at the water side of the mainframe and interconnects the top of the waterside legs. The inboard support girder interconnects the tops of the landside legs.

The cantilever boom of both types of crane is suspended below the girder support beams, and the horizontal sliding boom is suspended on rails supported thereby. The raisable boom gantry crane has the inboard end of the boom pivoted to the outboard girder beam whereby it can be raised to a position approaching but short of vertical In modern cranes, the boom is raised to approximately a 45 degree angle or more. A pair of trolley rails are mounted on the boom structure for supporting a container transport trolley which traverses the length of the boom to carry containers between a container ship berthed at the dock and the land side container pickup or deposition area.

A cargo container transport ship has many upward projecting components such as the bridge control tower, chimney flue, ship mounted cranes, radar antenna, and other superstructure. These items usually project or protrude above the bottom height of the gantry crane boom structure. Since that structure spans across the entire deck of a container ship, it is a particularly acute safety issue when the crane operator performs a crane movement operation. Normally, the operator can raise the boom structure to an upward-projecting stowed position, or retract the boom horizontally, to clear the ship superstructure when there is a need to move the crane and pass by these obstacles.

There is also heavy traffic on the ground level with numerous staff working to support the container moving operations. Safety is a major concern for the ground traffic control. Many truck chassis stop and start to deliver and carry away the containers during either the off-loading or on-loading operations. Other individuals are also in the work area checking the container identification numbers while mechanics can be installing or removing the semi-automatic twist locks which are mounted under each container box for self locking purposes when the containers are stacked on top of one another.

The crane operator's main effort during the transport of containers to or from a ship is naturally primarily focused on the container movement operations. The crane operator can hoist or lower the container vertically up and down while concurrently moving the container transport trolley horizontally inboard and outboard along the boom This permits the operator to position the container for deposition onboard the ship or to position an unloaded suspended lifting spreader for attachment to a container.

While the crane operator's main focus is on the container to be handled or in transit, a substantial portion of the time he is focusing on the container. He is looking toward ground level in order to pick up or deposit containers, or to attach a lifting spreader thereto, and to trolley the container to the proper deposition location. Occasionally the operator moves the gantry crane to the left or right direction, from his perspective, to position the boom on the next row of containers. In these circumstances, if the operator is focusing on the ground level containers, he can easily forget that the boom must be lifted up to a stowed position to pass a portion of the ship superstructure.

There have been many maritime incidents which have occurred in which the boom structure of the container crane accidentally collided with the structural or superstructure members of the container ship because of this error in attention. Such accidents can damage or even destroy the ship rigging and superstructure as well as damaging the boom structural members and severely interrupt normal crane operations. This is costly not only for the cost to repair damage either to the ship superstructure or the boom structure but also for the interruption of the shipping schedules.

The use of anti-collision systems in one manner or another for the purpose of preventing collisions between gantry crane booms and ship superstructures is known in the prior art. However, despite the numerous designs, forms, and arrangements disclosed by the prior art, which have been developed for the accomplishment of the various related objectives, purposes and requirements, the anti-collision systems heretofore devised and utilized consist basically of familiar, expected, and obvious configurations, combinations, and arrangements. This will become apparent from the following consideration of the closest known and relevant prior art.

The most common boom anti-collision system in use today is a mechanical type, stainless steel wiring system This consists of two piano wires mounted approximately 10 to 15 feet parallel to and laterally spaced from either side of the boom. One is attached to the boom tip on an extended member and the other end is fixed at the boom hinge location. When a ship superstructure engages the steel wire, it will deform the wire and eventually the wire will actuate a limit switch located at the end of the wire. The interrupt will trigger the gantry crane lateral motion drive to either completely stop or slowdown the lateral traverse motion depending upon the operators preferred mode of crane operation.

Other devices such as infrared sensors have also been utilized. However, these have not proven to be very effective or reliable since the system requires a target to receive the projected infrared signal. It is very difficult to adjust the target to receive the signal since the crane structure can be deflected depending upon loading conditions.

Another type of detection system utilizes a laser technique similar to the present invention. Reference is made to U.S. Pat. No. 5,343,739 issued Sep. 6, 1994, for a gantry crane collision avoidance device. The system utilizes transmitters mounted on opposite sides of the free end of the gantry crane boom for directing their respective laser beams rearward or inboard towards a plurality of photo electric receivers mounted in vertical spaced apart relation on respective sides of the gantry crane tower. This is an expensive system requiring extensive electrical installation wiring, machine adjustment, and equipment maintenance.

Another type of detection system utilizing laser beam technology requires a rotating laser detecting system which is mounted at the mid span of the boom facing directly toward the ship superstructure. The sophisticated device is also quite expensive and requires high maintenance due to the moving rotating device for the laser gun.

The boom protection system contemplated according to the present invention departs substantially from the conventional concepts and designs taught by the prior art. In doing so, it provides an apparatus primarily developed for the purpose of low-cost boom collision avoidance as described above, but it accomplishes the result in a different and improved manner for producing a protection system

### SUMMARY OF THE INVENTION

In view of the foregoing described and obvious disadvantages inherent in the known types of boom anti-collision devices presently existing in the prior art, the present invention provides a new boom protection system and construction wherein the same can be utilized in different types of gantry crane booms.

The general purpose of the present invention, which will be described hereafter in greater detail, is to provide a new boom protection system and method which has many of the advantages of the boom anti-collision devices mentioned above and many novel features that result in a new boom protection system which is not anticipated, rendered obvious, suggested, or even implied by any of the prior art boom anti-collision devices, either alone or in any combination thereof.

The more important features of the invention have been broadly outlined in order that the detailed description thereof, which follows, may be better understood and in order that the present contribution to an improvement in the art may be better appreciated. There are additional features of the invention that will be described hereinafter and which will form the subject matter of the claims appended hereto.

With respect to the claims hereof and before describing at least one preferred embodiment of the invention in detail, it is to be understood that the invention is not to be limited in its application to the details of construction and to the arrangements of the components which are set forth in the following description or illustrated in the drawings. The invention is capable of being created in other embodiments and of being practiced and carried out in various ways. Also, it is to be understood that the phraseology and terminology employed here are for the purpose of description and should not be regarded as limiting.

The present invention is a protection system for gantry cranes having a projecting cantilever boom suspended from girder support crossbeams which are part of the crane superstructure which in turn is supported by a crane mainframe. The system comprises a pair of variable range laser guns which are suspended from the superstructure and positioned on opposite sides of the boom and laterally spaced therefrom and disposed slightly below the boom. The laser guns have a reflective range setting proximate to the distance from laser guns to the outboard end of the boom and they are aimed parallel to the longitudinal axis of the boom. A means is provided which is responsive to a reflection of the laser beams emanating from the laser guns for alerting operators of the crane to the beam reflection.

Those skilled in the art will appreciate that the conception upon which this disclosure is based may readily be utilized as a basis for the designing of other forms, structures, methods, and systems for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a new and improved gantry crane boom protection system.

It is another object of the present invention to provide a new and improved gantry crane collision avoidance system which is less complex than the prior art, less costly to install, and more economical to maintain.

It is a further object of the present invention to provide a gantry crane boom protection system which can easily be retrofitted to existing horizontal sliding cranes and suspended boom cranes.

It is still another object of the present invention to provide a gantry crane boom protection system which is not subject to misalignment and breakdown due to loading and work cycles of the crane in which it is installed.

And it is yet a further object of the present invention to provide a gantry crane boom protection system which can be assembled and installed from readily available off-the-shelf electronic equipment.

Other objects and advantages of the present invention will become apparent when the method and apparatus of the present invention are considered in conjunction with the accompanying drawings.

### DESCRIPTION OF THE DRAWINGS

FIG. 1 is a side elevation of a typical suspended boom cargo container handling gantry crane; and

FIG. 2 is a front elevation thereof.

### DESCRIPTION OF THE PREFERRED EMBODIMENT

Reference is made to the drawings for a description of the preferred embodiment of the present invention wherein like reference numbers represent like elements on corresponding views.

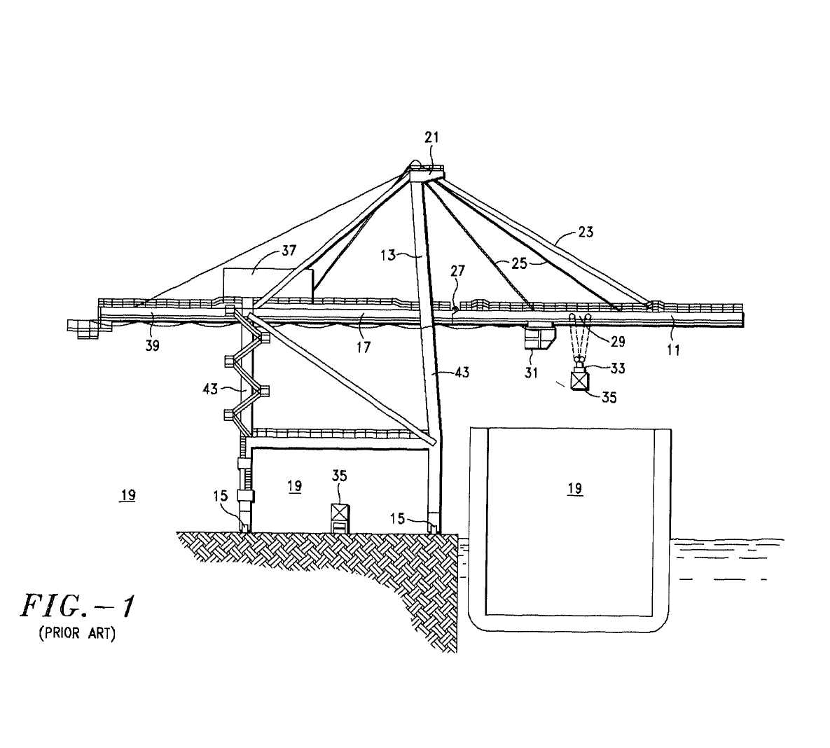

Reference is made to FIG. 1 which shows a typical A-frame gantry crane having a cantilevered rotatable boom 11 on which the present invention can be utilized. The crane superstructure 13 is supported on the crane truck trolleys or gantry trucks 15 which are mounted on dock rails which run parallel to the edge in the harbor dock. The superstructure supports a horizontal gantry 17 disposed generally mid height thereon at an elevated location above the cargo container pickup and deposition areas 19. The gantry is supported by the main legs of the superstructure which are mounted on the gantry trucks.

In the cantilevered rotatable boom design, sheaves are disposed at the pinnacle 21 of the superstructure 13 of the crane to guide wire rope reeving 23 which is used to rotate the outboard or cantilevered end of the boom to the raised stowed position above a 45-degree angle. The outboard end and middle of the boom are also supported from the pinnacle by mechanical links 25 when the boom is lowered to level and the wire rope reeving 23 is slack. The load supporting links for the rotatable boom are collapsible. The wire rope reeving which raises the boom takes the load off the links which collapse when the boom is rotated to its stowed position about its hinge point 27 at its inboard end proximate to the superstructure.

In most typical dockside cargo container handling operations, the gantry, or a portion thereof of a cargo container handling crane is either a slidable or a raisable cantilever boom extending from the crane superstructure. They are similar in that they both employ a movable trolley 29, usually with a suspended operators cab 31, which shuttles along the gantry 17 and boom 11 while suspending a cargo container lifting spreader 33. The spreader can be raised or lowered from the gantry by the operator and engages the cargo containers 35 which are located on the dock or on ship board to permit them to be lifted by the trolley for transport along the gantry to the deposition area 19 in a cargo container transport ship or on the dock.

The trolley is reciprocated along the gantry by a continuous wire rope reeving system which is driven by wire rope drums located in the machinery house 37. There are alternative designs for activating the trolley. The cargo container lift trolley 29 is mounted on rails on the gantry sections 11, 17, 39 and can traverse from one end of the gantry to the other. The trolley suspends the cargo container lifting spreader 33 from fleet through wire rope reeving by means of a detachable head block which carries the wire rope suspension sheaves. Different length spreaders can be secured to the head block or the spreader telescoped to accommodate correspondingly different size containers.

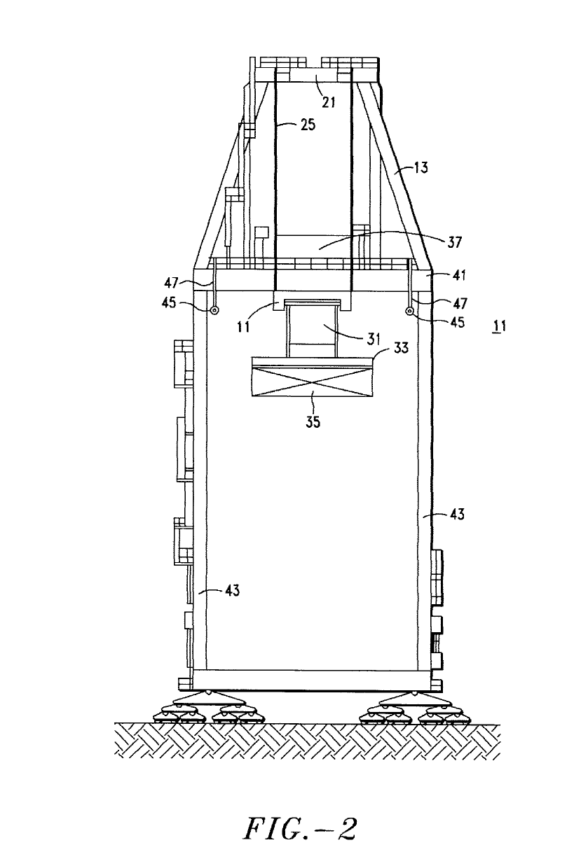

Reference is made to FIG. 2. The present invention is an anti-collision boom protection system for gantry cranes such as a horizontal sliding boom crane or a suspended boom crane; both of which have a projecting cantilever boom. The booms are suspended from girder support crossbeams 41 which are part of the crane superstructure 13. The superstructure of the crane is supported by the crane mainframe legs 43 at the four corners thereof. The crossbeams are the main integral members holding the tops of the shore side and landside legs together, and the booms of both types of cranes are positioned below the crossbeams.

The system with a present invention is comprised of a pair of variable range laser guns 45 suspended by poles or bars 47 from the superstructure 13. The laser guns are off-the-shelf items utilized in pulsed laser ranging systems for distance measuring devices. The present invention provides a new and unobvious use for those types of devices.

A pulsed laser ranging system is a distance measuring device that operates by transmitting a short high power pulse toward the target. A photodetector in the ranging system receives a reflection of the pulse. By knowing the time interval required for the signal to travel from the transmitter to the target and back to the receiver, it is possible to calculate the distance from the ranging system to the target. Laser distance measuring systems are used for surveying, ground profile measurements, gunfire ranging measurements (military), altimeters, space radars, satellite and missile tracking, and industrial machine tool control. However, the present invention is less complicated than the prior art as it does not require the associated time of light clocking equipment.

The laser guns 45 are preferably mounted at the lower ends of a pair of support brackets 47 which can be attached to Weber crossbeams 41 or Tuesday and rails mounted on top crossbeams. In the preferred embodiment of the present invention, the laser guns are positioned to extend approximately one foot below the bottom member of the boom structure. The guns are positioned on the opposite sides of the boom and laterally spaced therefrom a predetermined distance on each side thereof. The spacing is selected so that when the system is activated by light being reflected from an interfering shipboard structure, there is time sufficient for a moving gantry crane to come to a complete halt from full speed traverse on the crane rails. Experimental data indicates that in most cases the largest cranes can come to a complete stop in less than 12 feet from power cutoff with or without reverse power braking. The electric motors can be reversed to act as brakes and braking energy can be stored in batteries, or when properly filtered, the electrical energy generated by the braking action can be retuned to the electrical grid.

In the preferred embodiment of the present invention, the support brackets 47 for the laser guns 45 are secured to a part of the crane superstructure, such as the waterside girder support beam 41, at a distance to either side of the boom structure. The brackets position the laser guns at a predetermined lateral spacing from each side of the boom structure and approximately one foot below the bottom member thereof. The spacing is determined by the individual characteristics of each crane. The guns and laser beams are aimed parallel to the longitudinal axis of the boom and parallel to the bottom surface thereof whereby the guns fired the laser parallel to be adjacent edge of the boom.

The laser guns are typically powered either by 110 VAC or 12 VDC and will emit constant laser beams outward toward the boom cantilevered end direction. The laser guns have an adjustable reflective range setting which is adjusted to proximate to the distance from the laser guns to the outboard end of the boom. The effective detection and range of the guns can be adjusted depending upon the related crane boom length. The capability of laser detection distance adjustment insures that the system will not produce a false alarm from a ship in the channel passing by the berthed container ship. If any obstruction cuts through the path of the laser beam along the length of the beam, a portion of it will be reflected back to the laser gun receiver or photodetector and generate a preselected signal.

A responsive means is provided which is responsive to a reflection of the laser beams emanating from the laser guns. Responsive means includes the photodetector and electronic sensor which is actuated by the photodetector both of these elements can be housed in the laser gun case. If a reflection is detected by said responsive means, a pre-selected alert signal is activated by the electronic sensor and transmitted to the operator of the crane. This consists of numerous possible reactions such as: automatic shutdown of the gantry drive with or without reverse motor braking; automatic slowdown with a signal to the crane operator which still gives the operator sufficient time to stop the translational motion of the crane before it collides with a ship's superstructure by actuating reverse translational motor motion, or the signal can be a mandatory slowdown in addition to an audible warning which gives the operator time to select slowdown or stop of the translational motion. The primary response mode selected by most crane operators is an automatic shutdown of the crane translational motion. Alternatively, the operators next most often select automatic slowdown of the gantry motion with audible warning signals or an indicator light inside the operator cab. This warning indicator or alarm can be continued activated as long as the operator continues operation of the crane in the boom safety crane.

The present invention also contemplates a method of protection for gantry cranes having a projecting cantilever boom suspended from the crane superstructure. The steps comprise: locating distance ranging laser beam generators proximate to the crane superstructure; aiming the laser generators outboard therefrom below and parallel to the sides of the boom; mounting a photodetector proximate to the laser beam generators; exciting the lasers when the boom is lowered; actuating a responsive means if a laser beam is reflected to the photodetectors; and slowing or shutting down any lateral movement of the crane if the responsive means indicates a possible collision of the boom with a mechanical interfering object.

Thus, it will be apparent from the foregoing description of the boom protection system of the present invention in its preferred form that it will fulfill all the objects and advantages attributable thereto. While it is illustrated and described in considerable detail herein, the invention is not to be limited to such details as have been set forth except as may be necessitated by the appended claims.

We claim:

1. A protection system for gantry cranes having a projecting cantilever boom suspended from girder support crossbeams which are part of the crane superstructure which is supported by a crane mainframe, said system comprising
a pair of variable range laser guns suspended from said superstructure and positioned on opposite sides of said boom and laterally spaced therefrom and disposed slightly below said boom, said laser guns having a reflective range setting proximate to the distance from said laser guns to the outboard end of said boom and being aimed parallel to the longitudinal axis of said boom, and
means responsive to a reflection of laser beams emanating from said laser guns for actuating a crane translational motion speed alteration and alerting operators of said crane to said beam reflection.

2. The protection system of claim 1 wherein said responsive means actuates an automatic crane traverse speed slowdown.

3. The protection system of claim 1 wherein said laser guns are spaced laterally from the sides of said boom a pre-selected distance whereby actuation of said system by a beam reflection in turn actuates a crane translational motion shutdown which permits said crane to halt translational motion in said pre-selected distance.

4. A method of protection for gantry cranes having a projecting cantilever boom suspended the crane superstructure, the steps comprising
locating distance ranging laser beam generators proximate to said crane superstructure,
aiming said lasers outboard therefrom below and parallel to the sides of said boom,
mounting a photodetector proximate to said laser beam generators,
exciting said lasers when said boom is lowered,
actuating a responsive means if a laser beam is reflected to said photo detectors, and
slowing any lateral movement of said crane if said responsive means indicates a possible collision of said boom with a mechanical interfering object.
